(19) United States
(12) Patent Application Publication
(10) Pub. No.: US 2014/0023218 A1
(43) Pub. Date: Jan. 23, 2014

(54) SYSTEM FOR TRAINING AND IMPROVEMENT OF NOISE REDUCTION IN HEARING ASSISTANCE DEVICES

(71) Applicant: William S. Woods, Berkeley, CA (US)

(72) Inventor: William S. Woods, Berkeley, CA (US)

(73) Assignee: Starkey Laboratories, Inc., Eden Prairie, MN (US)

(21) Appl. No.: 13/550,911

(22) Filed: Jul. 17, 2012

(51) Int. Cl. H04R 25/00

(52) U.S. Cl. 381/317

(57) ABSTRACT

A system is provided for training and improvement of noise reduction in hearing assistance devices. In various embodiments the system includes a hearing assistance device having a microphone configured to detect sound. A memory is configured to store background noise detected by the microphone and configured to store a previous recording of speech. A processor includes a training module coupled to the memory and configured to perform training on a binary classifier using programmable feature extraction applied to a sum of the speech and the noise. The processor is configured to process the sound using an output of the binary classifier.

### TECHNICAL FIELD

This disclosure relates to hearing assistance devices, and more particularly to methods and apparatus for training and improvement of noise reduction in hearing assistance devices.

### BACKGROUND

Many people use hearing assistance devices to improve their day-to-day listening experience. Persons who are hard of hearing have many options for hearing assistance devices. One such device is a hearing aid. Hearing aids may be worn on-the-ear, behind-the-ear, in-the-ear, and completely in-the-canal. Hearing aids can help restore hearing, but they can also amplify unwanted sound which is bothersome and sometimes ineffective for the wearer.

Many attempts have been made to provide different hearing modes for hearing assistance devices. For example, some devices can be switched between directional and omnidirectional receiving modes. However, different users typically have different exposures to sound environments, so that even if one hearing aid is intended to work substantially the same from person-to-person, the user's sound environment may dictate uniquely different settings.

However, even devices which are programmed for a person's individual use can leave the user without a reliable improvement of hearing. For example, conditions can change and the device will be programmed for a completely different environment than the one the user is exposed to. Or conditions can change without the user obtaining a change of settings which would improve hearing substantially.

What is needed in the art is an improved system for training and improvement of noise reduction in hearing assistance devices to improve the quality of sound received by those devices.

### SUMMARY

The present subject matter provides a system for training and improvement of noise reduction in hearing assistance devices. In various embodiments the system includes a hearing assistance device having a microphone configured to detect sound. A memory is configured to store background noise detected by the microphone and configured to store a previous recording of speech. A processor includes a training module coupled to the memory and configured to perform training on a binary classifier using programmable feature extraction applied to a sum of the speech and the noise. The processor is configured to process the sound using an output of the binary classifier.

One aspect of the present subject matter includes a method for training and improvement of noise reduction for a hearing assistance device. Speech is recorded in a memory and sound is sensed from an environment using a hearing assistance device microphone. The sound is recorded using a memory, including recording background noise in a sound environment. Training is performed on a binary classifier using programmable feature extraction applied to a sum of the speech and the noise. According to various embodiments, the sound is processed using an output of the binary classifier.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is a block diagram of a system for training and improvement of noise reduction in hearing assistance devices illustrating an embodiment of a hearing assistance device including a processor with a sound classification module.

FIG. 2 is a block diagram of a system for training and improvement of noise reduction in hearing assistance devices illustrating an embodiment of an external device including a processor with a sound classification module.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

Current hearing aid single microphone noise reduction makes use of very limited information from the microphone signal, and can yield only slightly improved sound quality with no improvement in intelligibility. Prior attempts at binary classification of signal-to-noise ratio in the time/frequency domain improve speech intelligibility, but yield poor sound quality.

The present subject matter provides a system for training and improvement of noise reduction in hearing assistance devices. In various embodiments, the system includes a hearing assistance device having a microphone configured to detect sound. A memory is configured to store background noise detected by the microphone and configured to store a previous recording of speech. A processor includes a training module coupled to the memory and configured to perform training on a binary classifier using programmable feature extraction applied to a sum of the speech and the noise. The processor is configured to process the sound using an output of the binary classifier. This technique uses speech recorded previously (recorded at a different time and possibly a different place) and noise recorded online or “in the moment.” Other embodiments, in which the speech and noise are both recorded online, or both recorded previously, are possible without departing from the scope of the present subject matter. The speech and the noise can be recorded by the hearing assistance device, by an external device, or by a combination of the hearing assistance device and the external device. For example, the speech can be recorded by the external device and the noise by the hearing assistance device, or vice versa. The present subject matter improves speech intelligibility and quality in noisy environments using processing that is adapted online (while a wearer is using their hearing assistance device) in those environments.

When a wearer of a hearing assistance device enters a new, noisy environment a recording process is initiated of approximately one or two minutes of background noise with no conversation, in an embodiment. In various embodiments, the wearer initiates the recording process. The recording is done using the hearing assistance device, in an embodiment. In another embodiment, the recording is done using an external device, such as a streamer or cellular telephone, such as a smart phone. Other external devices, such as computers, laptops, or tablets can be used without departing from the scope of this disclosure. In various embodiments, there is also stored in memory (in the hearing assistance device or external device) a recording of a conversational partner speaking in quiet. After the recording period the hearing assistance device or external device uses the speech and noise to perform a supervised training on a binary classifier which uses pre-programmed feature extraction methods applied to the sum of the speech and noise. The speech and noise are summed together at a pre-specified power ratio, in various embodiments. The two states of the classifier correspond to those time/frequency cells when the ratio of the speech to noise power is above and below a pre-specified, programmable threshold. The supervision is possible because the training process knows the speech and noise signals before mixing and can thus determine the true speech to noise power ratio for each time/frequency cell, in various embodiments.

Because of the time delay in extracting the features, the classifier needs to classify future (relative to the feature time) time/frequency cells. The time delay between time/frequency cells and feature-computation output is variable to allow compromise between performance of the classifier and amount of audio delay through the hearing assistance device. The time delay can be controlled by changing the features (thus changing the amount of time data needed for computation) and changing a delay in the audio signal path. Once the training is completed the classifier is uploaded to the aid's processor and the aid begins classifying time/frequency cells in real time. When a cell is classified as above threshold a gain (G) of 1.0 is used, in an embodiment. When below the threshold, a gain G of between 0 and 1.0 is used, in an embodiment. Different values of G yield different levels of quality and intelligibility improvement. Thus the below-threshold G value is a programmable parameter in various embodiments. In various embodiments, the below-threshold G value is an environment-dependent parameter. Speech samples from different conversation partners can be stored in the aid or streamer and selected for the training, singly or in combinations. For combinations the training would proceed with single sentences from each talker separately summed with the noise. Either more background noise data can be used than with a single speaker, or different segmentations of a 1-2 minute recording can be used in various embodiments.

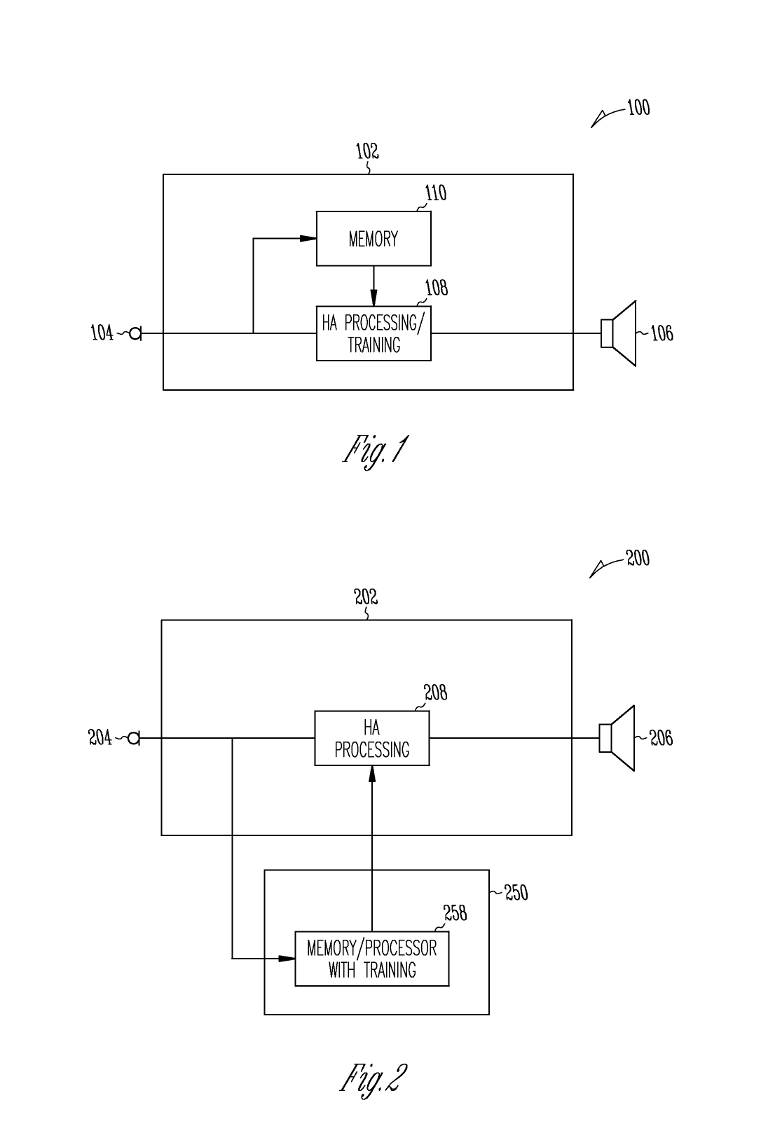

FIG. 1 is a block diagram of a system for training and improvement of noise reduction in hearing assistance devices illustrating an embodiment of a hearing assistance device including a processor with a sound classification or training module. The system 100 includes a hearing assistance device 102 having a microphone 104 and optional speaker or receiver 106. A memory 110 stores sound detected by the microphone, including a recording of background noise in a sound environment and a previous recording of speech. A processor 108 includes a training module coupled to the memory 110 and configured to perform training on a binary classifier using programmable feature extraction applied to a sum of the speech and the noise. The processor is configured to process the sound using an output of the binary classifier.

FIG. 2 is a block diagram of a system for training and improvement of noise reduction in hearing assistance devices illustrating an embodiment of an external device including a processor with a sound classification or training module. The system 200 includes a hearing assistance device 202 having a microphone 204 and optional speaker or receiver 206. An external device 250 has a memory 258 (the memory and processor with training module are shown together, but are separate units in various embodiments) that stores sound detected by the microphone, including a recording of background noise in a sound environment. In various embodiments, the external device has a microphone and recordings are made using the external device microphone in addition to or instead of the hearing assistance device microphone. Speech samples are previously recorded in the memory, in various embodiments. A processor 258 includes a training module coupled to the memory and configured to perform training on a binary classifier using programmable feature extraction applied to a sum of the speech and the noise. The hearing assistance processor 208 is configured to process the sound using an output of the binary classifier. The external device can communicate with the hearing assistance device using wired or wireless communications, in various embodiments.

Benefits of the present subject matter include one-shot, online adaptation, multiple target talker training, and low throughput delay. In addition, aspects of the present subject matter improve the quality of speech while decreasing the amount of processing used and allowing a more flexible application. In other embodiments, the training can be done over a longer period of time or offline, for example when a hearing assistance device is in a charger. In this example, the system automatically recognizes environments for which the system has previously been trained. Various embodiments of the present subject matter provide using data from multiple hearing assistance devices. The present subject matter can be used in other audio systems besides hearing assistance devices, such as for listening to music, translating dialogue, or medical transcription. Other types of audio systems can be used without departing from the scope of the present subject matter.

The examples set forth herein are intended to be demonstrative and not a limiting or exhaustive depiction of variations. The present subject matter can be used for a variety of hearing assistance devices, including but not limited to, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. Such devices are also known as receiver-in-the-canal (RIC) or receiver-in-the-ear (RITE) hearing instruments. It is understood that other hearing assistance devices not expressly stated herein may fall within the scope of the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A system, comprising:
a hearing assistance device including a microphone configured to detect sound;
a memory configured to store background noise detected by the microphone and configured to store a previous recording of speech; and
a processor including a training module coupled to the memory and configured to perform training on a binary classifier using programmable feature extraction applied to a sum of the speech and the noise, wherein the processor is configured to process the sound using an output of the binary classifier.

2. The system of claim 1, wherein two states of the binary classifier correspond to time/frequency cells when a ratio of speech to noise power is above and below a programmable threshold.

3. The system of claim 2, wherein the programmable threshold includes a gain (G) of 0.5.

4. The system of claim 1, wherein the sum of the speech and the noise includes a sum at a programmable power ratio.

5. The system of claim 1, wherein the hearing assistance device includes the memory.

6. The system of claim 1, wherein the hearing assistance device includes the processor.

7. The system of claim 1, wherein the memory is included in an external device.

8. The system of claim 7, wherein the external device includes a streaming device.

9. The system of claim 7, wherein the external device includes a cellular telephone.

10. The system of claim 1, wherein the processor includes a first portion housed with the hearing assistance device and a second portion external to the hearing assistance device.

11. A method for training and improvement of noise reduction for a hearing assistance device, the method comprising:
recording speech in a memory;
sensing sound from an environment using a hearing assistance device microphone;
recording the sound using the memory, including recording background noise in a sound environment;
performing training on a binary classifier using programmable feature extraction applied to a sum of the speech and the noise; and
processing the sound using an output of the binary classifier.

12. The method of claim 11, further comprising classifying future time/frequency cells using the binary classifier.

13. The method of claim 11, wherein two states of the binary classifier correspond to time/frequency cells when a ratio of speech to noise power is above and below a programmable threshold.

14. The method of claim 13, wherein the programmable threshold includes a gain (G) of 0.5.

15. The method of claim 11, wherein the sum of the speech and the noise includes a sum at a programmable power ratio.

16. The method of claim 11, wherein recording the sound using the memory includes using an external device.

17. The method of claim 16, wherein the external device includes a streaming device.

18. The method of claim 16, wherein the external device includes a cellular telephone.

19. The method of claim 11, wherein recording the sound includes providing for initiation of the recording by a wearer of the hearing assistance device.

20. The method of claim 11, wherein recording the sound includes recording the sound for approximately one minute.
